(19) United States
(12) Patent Application Publication
(10) Pub. No.: US 2007/0243518 A1
(43) Pub. Date: Oct. 18, 2007

(54) Continuous cardiac perfusion preservation with PEG-HB for improved hypothermic storage

(75) Inventors: Danny L. Serna, Atlanta, GA (US); Jeffrey C. Milliken, Newport Coast, CA (US); Ralph E. Purdy, Irvine, CA (US)

Correspondence Address: STOUT, UXA, BUYAN & MULLINS LLP, 4 VENTURE, SUITE 300, IRVINE, CA, 92618, US

(73) Assignee: The Regents of the University of California, Oakland, CA (US)

(21) Appl. No.: 11/712,829

(22) Filed: Feb. 28, 2007

Related U.S. Application Data
(63) Continuation of application No. 10/018,534, filed on Nov. 7, 2002, now abandoned.
(60) Provisional application No. 60/139,819, filed on Jun. 17, 1999.
(60) Provisional application No. 60/143,709, filed on Jul. 14, 1999.

(51) Int. Cl. A01N 1/02

(52) U.S. Cl. 435/1.2; 435/1.1

(57) ABSTRACT

Efforts to extend myocardial preservation for transplantation by perfusion with prior crystalloid based solutions have been limited by edema and compromised function. Hypothermic perfusion preservation with a polyethylene glycol (PEG) conjugated hemoglobin solution extends preservation times. The polyethylene glycol (PEG) conjugated hemoglobin solution comprises PEG-Hb, and at least one of the constituents selected from the group of human albumin, dextrose, heparin sodium, lidocaine HCl, MgSO₄, KCl, CaCl₂, Tromethamine (THAM) solution, NaCl, NaHCO₃, and Na₂HPO₄/NaH₂PO₄. Comparison of cardiac function after continuous perfusion using a hypocalcemic normokalemic crystalloid perfusate is made with and without the addition of PEG-Hemoglobin (Hb).

### BACKGROUND OF THE INVENTION

1. Field of the Invention

The invention relates to a method and apparatus for continuous cardiac perfusion preservation for improved hypothermic storage.

2. Description of the Prior Art

The current method of donor heart preservation for clinical transplantation involves cold cardioplegic arrest and storage at near freezing temperatures. Because of ongoing ischemia, this preservation technique prohibits extended storage of donor organs, use of advanced methods of tissue typing, and delivery of donor hearts over long distances. The current preservation technique may also lead to irreversible graft damage. Preservation by continuous coronary artery perfusion allows for greater preservation times than hypothermic ischemic preservation.

Continuous coronary artery perfusion allows for an ongoing supply of substrate as well as removal of metabolic waste products. Three general types of solutions have been examined for their efficacy as cardiac preservation agents. Perfusion with crystalloid, cardioplegia-type solutions have shown limited promise. Perfusion preservation using these solutions has been limited by edema and compromised cardiac function. Similarly, studies examining perfluorocarbon emulsions as perfusion preservation media for the donor heart have produced mixed results. Further, perfluorochemicals are expensive and have questionable safety profiles when used systemically.

Hemoglobin-based blood substitutes have more recently been developed for use as blood replacements in trauma and surgery. Use of these solutions as organ preservation solutions may lengthen the window of ex vivo cardiac preservation with a concomitant improvement in recovery of cardiac function.

Donor organ preservation for transplantation is performed using ischemic hypothermic immersion storage in crystalloid based solutions. Preservation time for the donor cardiac allograft, for example, is limited to a maximum of 4 to 6 hours using this technique. Hypothermic perfusion preservation with an oxygen carrying hemoglobin solution should extend preservation times and decrease ischemic injury of transplantable organs. Perfusion preservation using the invention will also allow sufficient time for complex tissue typing, allow better donor-recipient matching, and allow for transportation of organs to more distant sites.

Polyethylene Glycol- Hemoglobin (PEG-Hb) and other polyalkyleneoxide conjugated hemoglobins have been previously prepared and used for perfusion preservation such as described in U.S. Pat. No. 5,312,808. However, it was necessary to fractionate the polyalkylene oxide-conjugated hemoglobins to isolate a fraction with a molecular weight greater than about 85000 daltons and a degree of substitution of at least five polyalkylene oxide-conjugates per hemoglobin molecule to avoid hemoglobinurea. In the past, the problem of cardiac allograft preservation was accomplished by hypothermic immersion storage of the allograft in cardioplegia or saline solution. The disadvantage of this technique was the lack of delivery of oxygen, nutrition, and electrolytes to the donor organ allograft. Use of PEG-Hb alone is not useful to the myocardium and cannot be used for the purpose of effective organ preservation.

### BRIEF SUMMARY OF THE INVENTION

Therefore, in accordance with the present invention, there is provided a substantially improved solution composition containing PEG-Hb, electrolyte salts, soluble proteins, certain agents affecting the cardiovascular system and nutritional formulation which was found to improve and extend myocardial preservation times above that achieved by standard techniques.

The invention differs from prior art significantly in terms of the composition of the solution. The claimed composition of this invention contains PEG-Hb as one of numerous components. In addition to PEG-Hb, the invention contains human insulin, human albumin, dextrose, heparin sodium, lidocaine HCl, MgSO₄, KCL, CaCl₂, tromethamine (THAM), NaCl, Na₂HPO₄/NaH₂PO₄, NaHCO₃, without which PEG-Hb is useless to the myocardium and cannot be used for the purpose of effective organ preservation. Na₂HPO₄/NaH₂PO₄ is understood to mean either Na₂HPO₄, NaH₂PO₄ or both. In other words, the invention is comprised of PEG-Hb and with one or more electrolyte(s), soluble protein(s), nutritional formulation(s), and agents acting on the cardiovascular systems such as anticoagulant(s), and antiarrythmic agent(s) in buffer (s). Many substitutes and combinations of these constituents is possible without departing from the scope of the invention. For example, instead of the nutritional formulation being comprised of dextrose other simple sugars or carbohydrates and their metabolites may be equivalently substituted. The nutritional formulation may be understood to include antioxidants such as glutathione, lipoic acid, N-acetyl cysteine, vitamins such as ascorbic acid and flavonoids, L-thiazolidine-2-one-4-carboxylic acid and other antioxidants obvious to the one skilled in the art. Any tissue nutrient now known or later devised may be substituted or included. Similar equivalent substitutions for the named constituents in the preferred embodiment may be used for each of the listed electrolytes, soluble proteins, nutritional formulations, cardiovascular agents and buffer(s).

The invention includes a composition of matter, namely a polyethylene glycol conjugated bovine hemoglobin based solution for the purpose of ex vivo donor organ preservation and the use of the same. The purpose of the solution is to preserve donor human and animal organs, ex vivo, prior to transplantation. The fundamental principle of the solution is to provide an oxygen, nutritional and electrolyte environment to the tissue of the donor organ that is conducive to ex vivo preservation such that the donor organ will regain acceptable function post transplantation.

The advantages of the invention include provision of oxygen, a carbohydrate energy source, continuous metabolite washout, and continuous perfusion with an isotonic, normokalemic, hypocalcemic solution that drastically improves myocardial preservation over current techniques considered the standard of care. Hypothermic perfusion preservation of the rabbit heart using the composition of this invention for periods of 8 hours has been shown to significantly improve myocardial preservation and left ventricular function compared to 4 hours of hypothermic immersion storage in saline solution, which is considered to be the standard of care. In the illustrated embodiment, hypothermic perfusion preservation of the rabbit heart using the composition of this invention for periods of 8 hours has also been shown to produce left ventricular function that tends toward superiority over fresh control rabbit hearts immediately after removal from the chest.

Perfusion preservation is superior to immersion preservation because it allows for the continuous washout of metabolic waste products, as well as the delivery of physiologically essential nutrients, metabolic substrates, and oxygen to the myocardium. For several reasons, perfusion preservation has not been applied clinically to ex vivo cardiac preservation for transplantation. First, a user friendly, practical, and portable perfusion preservation device is not currently available. Second, most research into perfusion preservation to date has been performed using crystalloid cardioplegia solutions and perfluorocarbons. Crystalloid cardioplegia solutions, unfortunately, carry very little oxygen and hence their use is associated with considerable ischemic injury to the donor organ. Perfluorocarbon based solutions have demonstrated mixed results for the purpose of cardiac preservation and are extremely expensive.

Perfusion preservation using stroma-free hemoglobin based solutions represents an innovative means of ex vivo cardiac preservation. Stroma-free hemoglobins were initially developed as blood substitutes for use in the treatment of life threatening hemorrhage secondary to trauma. There is strong interest among transplant scientists in the potential for these solutions as organ preservation solutions. The invention shows the utility of perfusion preservation using a normokalemic hypocalcemic polyethylene glycol substituted bovine hemoglobin based solution.

The invention is better visualized in the following drawings wherein like elements are referenced by like numerals.

### BRIEF DESCRIPTION OF THE DRAWINGS

FIG. 1 is an diagram of an isolated heart perfusion preservation circuit.

FIG. 2 is a graph of developed LV pressure at 15, 75, and 135 minutes after preservation. The Student's t-test was used to test for significance between groups. A p value of less than 0.05 was considered significant.

FIG. 3 is a graph of the maximum rate of LV contraction at 15, 75, and 135 minutes after preservation. The Student's t-test was used to test for significance between groups. A p value of less than 0.05 was considered significant.

FIG. 4 is a graph of the maximum rate of LV relaxation at 15, 75, and 135 minutes after preservation. The Student's t-test was used to test for significance between groups. A p value of less than 0.05 was considered significant.

The invention and its various embodiments are better understood by now turning to the descriptions of the illustrated examples in the detailed description of the preferred embodiments.

### DETAILED DESCRIPTION OF THE PREFERRED EMBODIMENTS

Cardiac preservation for transplantation is limited by ischemic hypothermic storage of 4 to 6 hours. Hypothermic perfusion preservation using a novel oxygen carrying hemoglobin solution composition may extend preservation times and decrease ischemic injury. The disclosure below compares cardiac function after 24 hrs of continuous hypothermic perfusion with a novel polyethylene glycol-hemoglobin (PEG Hb) containing solution composition to the clinical standard of hypothermic ischemic preservation.

The illustrated composition of the PEG-Hb based preservation fluids is as follows: 3% PEG-Hb, KCl (4.7 mEq/L), NaCl (148.7 mmol/L), Na₂HPO₄/NaH₂PO₄ (2.5 mmol/L), NaHCO₃ (2.5 mmol/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), and 0.3M tromethamine (THAM) solution (7.3 cc/L).

The composition of the crystalloid preservation solution is as follows: KCl (4.7 mEq/L), NaCl (150.7 mEq/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), and 0.3M tromethamine (THAM) solution (7.3 cc/L).

During ex vivo cardiac preservation, the pH of the invention is maintained at 7.1, as measured at 37° C., and 7.4 as measured at 20° C. utilizing the appropriate buffers. The partial pressure of oxygen, PO₂, is maintained above 600 mm Hg. New Zealand White rabbits were used to obtain data to support the illustrated embodiment.

The proposed use of the invention is for the ex vivo preservation of human and animal donor organ allografts during transportation from the donor to the recipient for the purpose of transplantation. In addition to its use for ex vivo myocardial, lung, kidney and other organs preservation, this PEG-Hb containing composition has tremendous potential utility for in vivo myocardial preservation during open-heart surgery as well as a blood substitute or blood replacement. The disclosed formulation of the PEG-Hb containing solution would likely be extremely effective for the purposes of intravascular volume replacement, blood substitution, and as an alternative to blood transfusion during or after surgery of any sort including, but not limited to open heart surgery, and including trauma induced blood loss.

By increasing the potassium concentration of the solution to reflect intracellular levels, this simple modification of the disclosed solution composition could very well be useful for the purposes of cardioplegia or hypothermic cardiac arrest as well as myocardial preservation during open-heart surgery. The solution could be administered in order to effectively maintain myocardial arrest as well as improve myocardial preservation during open-heart surgery.

Efforts to extend myocardial preservation for transplantation by crystalloid perfusion have been limited by edema and compromised function. Hypothermic perfusion preservation with oxygen carrying hemoglobin solution extends preservation times. Comparison of cardiac function after continuous perfusion with PEG -Hemoglobin (PEG Hb) containing composition of this invention to a physiologic crystalloid perfusate is made below in the examples.

### EXAMPLE 1

The hearts of 20 anesthetized and ventilated NZW rabbits were harvested after cold cardioplegic arrest. Group I (n=10) hearts were continuously perfused with a normokalemic hypocalcemic bovine PEG-Hb based solution formulation at 20° C. and 30 mmHg of aortic root pressure for 8 hours. Group II (n=10) hearts were identically preserved with a crystalloid solution identical in composition used in Group I hearts, but with deletion of PEG-Hb.

Twenty adult male New Zealand White rabbits (3 to 3.5 kg) were anesthetized using an intramuscular injection of 50 mg ketamine and 5 mg xylazine per kilogram. Lactated Ringers solution was infused through an intravenous catheter in a marginal ear vein at a rate of 5 to 15 cc/hr. The rabbits were mechanically ventilated using a Servo Animal Ventilator (model #900C, Siemens-Elema, Sweden). Anesthesia was maintained with intravenous ketamine/xylazine in a 1:1 ratio. A median sternotorny followed by a longitudinal pericardial incision was performed, exposing the heart and mediastinal vessels. All rabbits received 1,000 U heparin sodium/kg intravenously. The innominate artery, the aortic arch between the brachiocephalic trunk and left carotid artery, as well as the inferior and superior vena cava were then identified and isolated. Upon ligation of the inferior and superior vena cava, the innominate artery was cannulated using an 18 Ga angiocatheter. 60 cc of hypothermic cardioplegia solution (2-4° C.) was administered to the coronary arteries via the innominate artery over 3 minutes. An arteriotomy was made in the pulmonary trunk to decompress the right ventricle. Hypothermic normal saline (2-4° C.) was used to topically cool the heart during cardioplegia infusion. The heart was quickly excised. The heart was trimmed of excess soft tissue including lungs, trachea, and thymus. All hearts were placed onto the preservation circuit by cannulation at the ascending aorta. Coronary perfusion was begun within 5 minutes of cardiectomy. All hearts were preserved for 8 hours by continuous coronary artery perfusion. Aortic root pressure was maintained at 30 mm Hg. Temperature of the perfusate was maintained at 20° C. All hearts were perfused and immersed in the respective preservation solutions for the entire 8-hour preservation period. 95% O₂/5% CO₂ administration was begun using the membrane oxygenator 15 minutes after transfer of the heart to the preservation circuit. pO₂ was maintained at a level greater than or equal to 600 mHg.

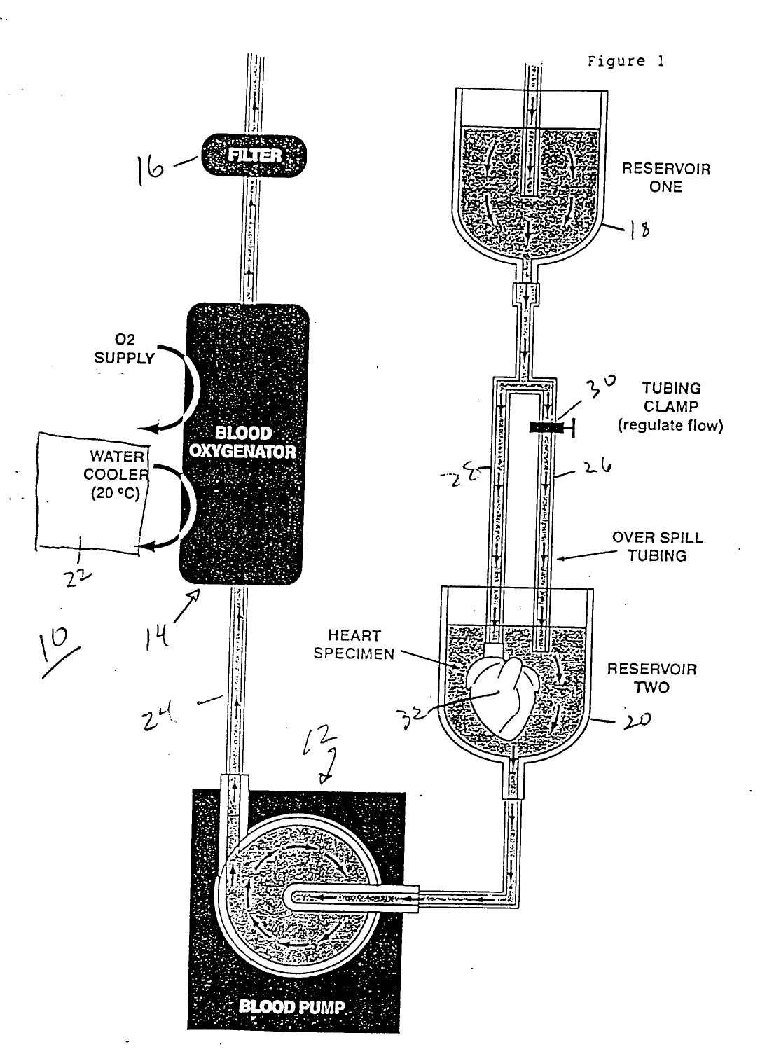

The preservation circuit 10 as diagrammatically shown in FIG. 1 is comprised of a centrifugal pump 12 (Medtronic Bio-Medicus pumphead, Model # 9154R, Medtronic Blood Systems, Inc., Anaheim, Calif.) and Bio-Console (Medtronic Bio-Medicus Inc., Eden Prairie, Minn.), which pumped blood through line 24 to an adult membrane oxygenator 14 (Sams/Terumo), C-Flex Consolidated Polymer tubing (Fischer, Largo, Fla.). The temperature of perfusate was maintained by a heater/cooler 22 (Fisher Scientific Inc., Pittsburgh, Pa.), which was circulated through the membrane oxygenator 14 in a heat exchange relationship. Oxygenated blood then flowed from oxygenator 14 to a 40 um blood filter 16 (Pall Biomedical, Inc, Fajardo, PR), and to two glass reservoirs 18 and 20 communicated in serial circuit. Blood is first collected in reservoir 18 and flowed through lines 26 and/or 28 to second reservoir 20. Line 28 communicated with the aortic inlet of heart 32 held in reservoir 20. Line 26, which can be controlled by valve 30, communicates to the body of second reservoir 20 and provides a means of adjusting fluid levels therein in a manner compatible with the flow through heart 32.

Bovine PEG-Hb was obtained from Enzon, Inc. (Piscataway, N.J.) in a solution containing 6% PEG-Hb, 5 mM NaH₂PO₄, 5 mM NaHCO₃, and 150 mM NaCl. Polyethylene glycol (PEG) conjugated bovine Hb (PEG-Hb) was prepared by the isolation of hemoglobin from bovine red blood cells obtained from a closed herd. The material was purified and each Hb molecule modified with approximately 12 succinimidyl carbonate polyethylene glycol strands (5000 daltons) to yield a 6% (g/dL) Hb solution with methemoglobin less than 5% of total hemoglobin, endotoxin less than 0.5 EU/mL, and viscosity 3.1 cP at 37° C. Normal saline solution (0.9% NaCl) was obtained from Baxter Health Care (Irvine, Calif.). Solutions were monitored using a blood gas analyzer (288 Blood Gas System, Ciba-Corning Diagnostics Corp., Medfield, Mass.), an Automated Coagulation Timer (Medtronic Hemotec, Inc., Englewood, Col.) and a blood glucose meter (Lifescan, Inc., Milpitas, Calif.). Membrane oxygenators were obtained from Sams/Terumo.

The composition of one of the most preferred PEG-Hb based preservation fluids is as follows: 3% bovine PEG-Hb, KCl (4.7 mEq/L), NaCl (148.7 mmol/L), NaH₂PO₄/Na₂HPO₄ (2.5 mmol/L), NaHCO₃ (2.5 mmol/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), 0.3M tromethamine (THAM) solution (7.3 cc/L). The osmolality of the 3% PEG-Hb solution is 324 mOsm/kg.

The composition of the crystalloid preservation solution is as follows: KCl (4.7 mEq/L), NaCl (150.7 mEq/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), and 0.3M tromethamine (THAM) solution (7.3 cc/L). The osmolality of the crystalloid preservation solution is 324 mOsm/kg.

At the end of the 8-hour preservation period, all hearts were transferred to an isolated heart perfusion apparatus for purposes of data collection. Coronary perfusion via the aortic root was immediately begun at 37° C. and 59 mmHg aortic root pressure. 95% O₂/5% CO₂ administration was begun using the membrane oxygenator 15 minutes after transfer of the heart to this circuit. pO₂ was maintained at a level greater than or equal to 600 mHg.

After 15 minutes of coronary perfusion in this position, coronary flow, heart rate, left ventricular developed pressure (LVP), peak dP/dt (rate of left ventricular pressure development), and peak −dP/dt (rate of left ventricular pressure relaxation) were measured. Coronary flow and heart rate were measured every 15 minutes for 2 hours. LVP, peak dP/dt, and peak −dP/dt were measured again at 75 and 135 minutes following transfer to the second circuit. Heart rate was measured by counting left ventricular contractions over the course of one minute. Coronary flow was measured by collecting the effluent that exited from the pulmonary artery over course of one minute. LVP, peak dP/dt, and peak −dP/dt were measured in the beating, nonworking position during continuous coronary artery perfusion. Developed left ventricular pressure (systolic minus diastolic) and peak rates of left ventricular pressure development (dP/dtₘₐₓ) and relaxation (−dP/dtmax) were measured using a left ventricular force transducer (Biopac Systems, Inc., Santa Barbara, Calif.). Data from the LV force transducer was digitized using an analog to digital converter (Biopac Systems, Inc., Santa Barbara, Calif.) and analyzed using Acknowledge software (Version 3.2.6, Biopac Systems, Inc., Santa Barbara, Calif.) and a desktop computer (Nexstar, Fremont, Calif.). The testing circuit was that shown in described in FIG. 1 where a 40 μm blood filter 16 (Pall Biomedical, Inc, Fajardo, PR) was used.

Left ventricular function was assessed in all hearts in both groups using a standard physiologic crystalloid solution. The composition was as follows: KCl (4.7 mEq/L ), NaCl (151.5 mEq/L), MgSO₄ (5.0 mEq/L), CaCl₂ (2.0 mEq/L), lidocaine HCl (12.5 mg/L), heparin sodium (1250 units/L), dextrose (6.1 mOsm/L), human insulin (30.7 units/L), and 0.3M tromethamine (THAM) solution (6.1 cc/L).

After 135 minutes of retrograde aortic perfusion on the testing circuit, the ventricular myocardium of the initial 5 hearts in each group was dissected free of atria and other soft tissue. The left ventricular myocardium was weighed before and after desiccation at 110° C.

Data are reported as mean±SE. Statistical analysis was performed using Systal 7.0.1 software package (SPSS, Inc., Chicago, Ill.). The Student's t-test was used to test for significance between groups. A p value of less than 0.05 was considered significant.

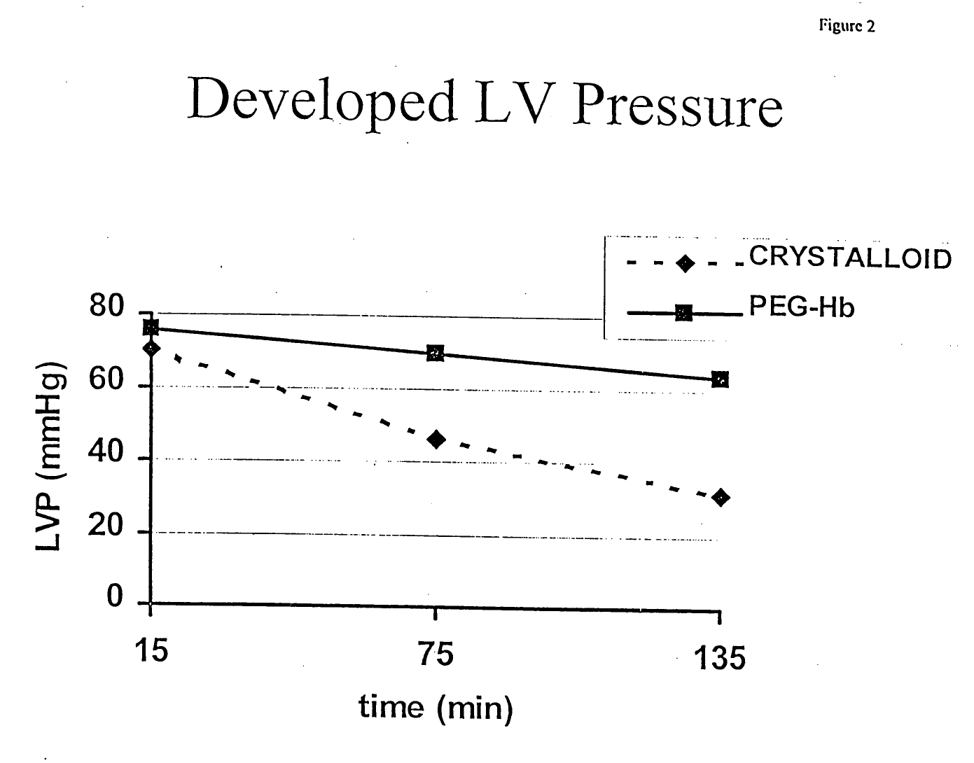

Developed LV pressure at 0.5 cc LV volume was similar between PEG-Hb composition of this invention and crystalloid preserved hearts at 15 minutes after the end of preservation (p=0.46, FIG. 2). However, developed LV pressure at 0.5 cc LV volume was superior in hearts preserved in PEG-Hb containing composition compared to hearts preserved in crystalloid formulation at 75 (p=0.006) and 135 minutes (p=0.002) after the end of preservation.

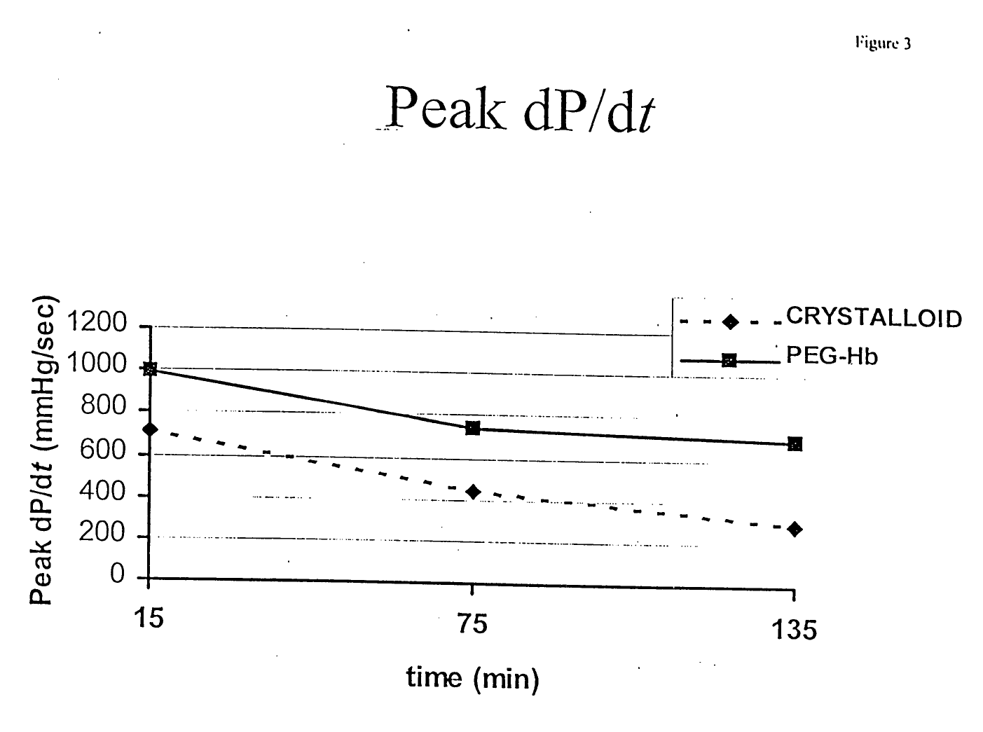

Peak dP/dtₘₐₓ at 0.5 cc LV volume tended toward superiority amongst hearts preserved using PEG-Hb solution composition compared to hearts preserved using crystalloid formulation, at 15 minutes after the end of preservation (p=0.10, FIG. 3). However, peak dP/dtₘₐₓ at 0.5 cc LV volume was superior in hearts preserved using PEG-Hb solution composition compared to hearts preserved using crystalloid formulation at 75 (p=0.01) and 135 minutes (p=0.001) after the end of preservation.

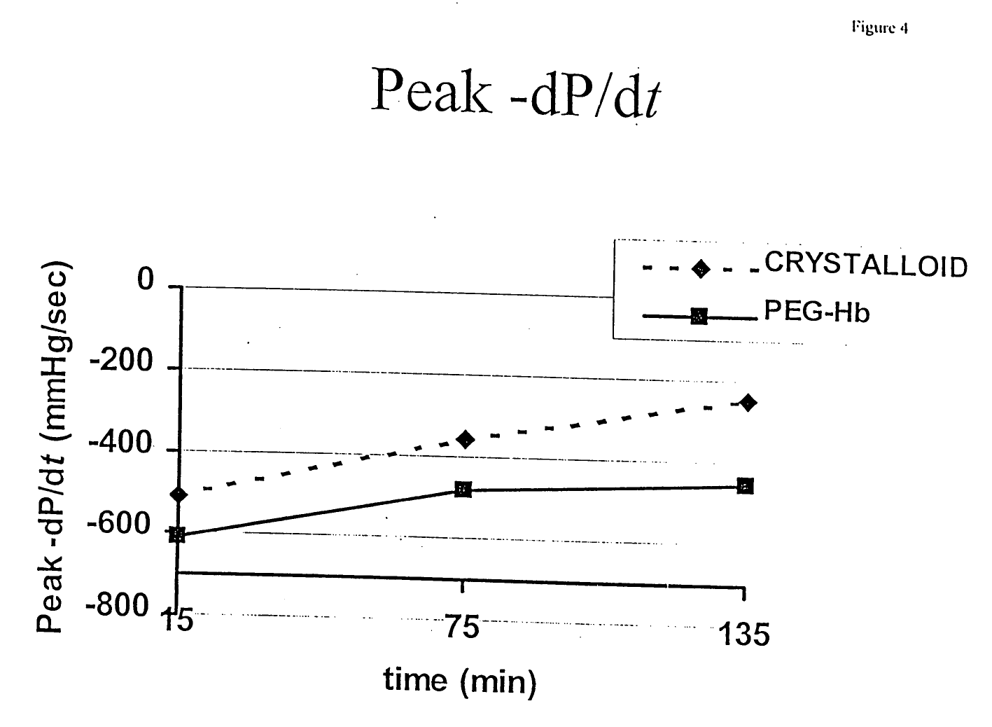

Peak −dP/dtₘₐₓ at 0.5 cc LV volume was similar in hearts preserved in PEG-Hb composition and crystalloid formulation at 15 minutes (p=0.27) after the end of preservation and tended toward superiority at 75 minutes after the end of preservation (p=0.07, FIG. 4). Peak −dP/dtₘₐₓ at 0.5 cc LV volume was superior in hearts preserved in PEG-Hb composition compared to hearts preserved in crystalloid formulation at 135 minutes (p=0.006) after the end of preservation.

Percent water of total ventricular weight was 82.0% for Group I, and 81.6% for Group II (p=NS). Coronary flow after preservation was similar between hearts preserved in PEG-Hb based composition and crystalloid formulation. Heart rate was the same for group I and II through the testing period (p=NS, Table 1).

Heart Rate

| | PEG-Hb | Crystalloid | |
|---|---|---|---|
| Time (minutes) | Composition | Formulation | P value |
| 15 | 117 ± 8.4 | 100.8 ± 8.4 | 0.19 |
| 30 | 104.9 ± 7.9 | 98.4 ± 4.9 | 0.48 |
| 45 | 98.8 ± 6.6 | 95.2: ± 4.6 | 0.66 |
| 60 | 94.1 ± 6.6 | 97.6 ± 5.7 | 0.70 |
| 75 | 90.9 ± 6.8 | 96.2 ± 5.5 | 0.55 |
| 90 | 99.2 ± 6.6 | 97.0 ± 3.5 | 0.77 |
| 105 | 97.8 ± 6.3 | 89.1 ± 4.8 | 0.30 |
| 120 | 95.0 ± 6.4 | 75.8 ± 11.5 | 0.14 |
| 135 | 100.5 ± 6.3 | 73.9 ± 13.7 | 0.07 |

### EXAMPLE 2

The hearts of 9 anesthetized and ventilated NZW rabbits were harvested after cold cardioplegic arrest. Group 1 (n=4) hearts were continuously perfused with PEG-Hb composition of this invention at 20° C. and 30 mm Hg for 8 hours. Group II (n=5) hearts were continuously perfused with crystalloid formulation for 8 hours at 20° C. Cardiac function was measured with a left ventricular balloon at 0, 1, and 2 hours after transfer to a standard crystalloid Langendorff circuit.

Heart rate was the same for group I and II through the testing period (89.6 vs. 91.1, p=0.57). Developed left ventricular pressure (systolic minus diastolic) at 0.6 cc left ventricular volume was greater in Group I (76.17:t19.2 mm Hg), than in Group II (52.0:t25.21, p=0.021). Maximum dP/dt at 0.6 cc left ventricular volume was greater in Group I (854.4 7:t381.8 mmHg/sec ) than in Group II (485.10:t284.14 mm Hg/sec, p=0.025). Percent water of total ventricular weight was 82.0% for Group I and 81.6% for Group II. Continuous perfusion preservation of rabbit hearts for 8 hrs with PEG-Hb composition at 30 mm Hg and 20° C. yields left ventricular function superior to 8-hr perfusion with crystalloid formulation, despite similar myocardial edema. Extended cardiac perfusion preservation with PEG-Hb composition of this invention is thus useful in organ transplantation.

### EXAMPLE 3

The hearts of 25 anesthetized and intubated NZW rabbits were harvested after cold cardioplegic arrest. Group I (n=7) hearts were perfused with a PEG-Hb solution of the claimed composition at 20° C. and 30 mmHg for 24 hours. Group II (n=10) hearts were preserved by cold ischemic storage for 4 hours at 4° C., and Group III (n=8) were tested immediately after harvest. Left ventricular function was measured in the non-working state immediately and 2 hours after transfer to a standard crystalloid Langendorff circuit.

Developed left ventricular pressure at 0.5cc left ventricular volume was similar in Group I (54.2:1:2.6 mmHg) and Group II (49.1:1:5.4 mmHg,p=0.5) but greater in Group III (69.4:1:5.1 mmHg, p=0.02). Maximum −dP/dt at 0.5 cc left ventricular volume was similar in Group I (−398.1:1:19.0 mmHg/sec), Group II (−354.8:1:49.1 mmHg/sec,p=0.2) and Group III (−456.2:1:44.1 mmHg/sec,p=0.7). Maximum +dP/dt at 0.5 cc left ventricular volume was also similar in Group I (660.3:1:49.5 mmHg/sec), Group II (428.4:1:54.9 mmHg/sec,p=0.3) and Group III (514.6:1:48.9 mmHg/sec,p=0.6).

Continuous perfusion preservation of rabbit hearts for 24 hrs with this novel PEG-Hb solution composition at 30 mmHg and 20° C. yields left ventricular function that is similar to 4 hrs of ischemic hypothermic storage and to that of fresh control hearts.

### EXAMPLE 4

The hearts of 28 anesthetized and intubated NZW rabbits were harvested after cold cardioplegic arrest. Group I (n=10) hearts were continuously perfused via the aortic root with the novel PEG-Hb solution of the claimed composition at 20° C. and 30 mmHg for 8 hours. pO₂ was maintained at greater than 500 mmHg during the preservation phase. Group II (n=10) hearts were preserved by cold ischemic storage for4 hours at 4° C. Group III hearts (n=8) were tested immediately after their harvest. Left ventricular function was measured at 37° C. in the non-working state 15 min after transfer to a standard crystalloid Langendorff circuit.

Developed left ventricular pressure at 0.5 cc left ventricular volume was greater in Group I (75.7:J:10.3 rnmHg) than Group II (49.1:J:5.4mmHg,p=0.04) and similar to Group III (69.4:J:5.1mmHg, p=0.6). Maximum-dP/dt at 0.5 cc L V volume was greater in Group I 610.6:J:68.4 mmHg/sec) than Group II (−354.8:J:49.1 mmHg/sec,p=0.01) and tended toward superiority over Group III (−456.2:J:44.1 mmHg/sec,p=0.09). Maximum +dP/dt at 0.5 cc left ventricular volume was greater in Group I (964.9:J:156.6 mmHg/sec) than both Group II (428.4:J:54.9 mmHg/sec,p=0.004) and Group III (514.6:J:48.9 mmHg/sec, p=0.02).

Continuous perfusion preservation of the rabbit heart for 8 hrs with the PEG-Hb solution composition of this invention at 30 mmHg and 20° C. yields left ventricular function that is superior to 4 hrs of ischemic hypothermic storage. Furthermore, return of cardiac function after perfusion preservation using the PEG-Hb solution composition of this invention may be superior to that obtained in freshly arrested hearts. These data suggest that there may occur some recovery of myocardial function during perfusion preservation with this PEG-Hb solution composition after the ischemic insult of cardioplegic arrest. Perfusion preservation using this PEG-Hemoglobin solution composition may also be more useful than hypothermic ischemic storage in the reanimation of nonbeating heart donors.

Thus, it can now be appreciated that there are two general techniques of ex vivo organ preservation for transplantation, and specifically cardiac preservation for transplantation. The standard of care and commonly used technique is hypothermic ischemic immersion storage of the donor organ, and particularly cardiac allograft. The second method of organ, and particularly cardiac preservation is coronary perfusion preservation. These two methods can and have been used in combination with improved results.

The superior organ preservation results of the hearts preserved with PEG-Hb solution composition disclosed here are probably a result of a combination of both an oncotic and oxygen delivery effect of PEG-Hb. Data supporting an oxygen delivery effect of PEG-Hb has otherwise been obtained using exchange-transfusion in a rat model. Rats were exchange-transfused up to an 85% hematocrit reduction with either PEG-Hb, PEG-mHb (50%-methemoglobin), PEG-carbon monoxide (carboxy) hemoglobin (PEG-COHb), or PEG-human serum albumin (PEG-HSA). Survival at twenty-four hours after transfusion was 79% in the PEG-Hb group, 30% in the PEG-mHb group, and 0% for both PEG-COHb and PEG-HSA. Despite similar plasma expansion properties of the four solutions, the solution with greatest oxygen delivery capability led to greatest survival.

On a per gram basis, the oxygen carrying capacity of PEG-Hb is the same as would be found with unmodified tetrameric bovine Hb. PEGylation of Hb involves the covalent attachment of polyethylene glycol to stroma-free Hb tetramers. PEGylation does not appear to change the total oxygen carrying capacity of the Hb, but PEGylation does appear to alter the nature of oxygen transport. For example, because of its larger particle size, PEG-Hb remains within the vascular space for longer than otherwise unmodified Hb. In addition, PEGylation alters the oxygen affinity of bovine hemoglobin. The P₅₀ of bovine PEG-Hb is 15 torr at 37° C. Clearly, this is a relatively low P₅₀. Such high oxygen affinity begs the question of the ability of PEG-Hb to effectively deliver oxygen under normothermic and hypothermic conditions. Bovine PEG-Hb has been shown using the rat model to provide better tissue oxygenation than stroma-free bovine Hb (P₅₀-26 torr) or cross-linked bovine Hb (P₅₀-48 torr), both of which have lower affinity for oxygen than does PEG-Hb and therefore should theoretically be better tissue oxygenators. Furthermore, we also know that bovine Hb is unlike human Hb in that it does not require 2,3-diphosphoglycerate to lower its oxygen affinity, but rather requires only chloride ions, which are present in the PEG-Hb preservation solution. Finally, the Bohr effect is more pronounced in bovine Hb than human Hb, which would theoretically allow better delivery of oxygen at lower pH and temperature. The oncotic pressure of PEG-Hb is greatly enhanced by the conjugation of PEG to surface amino acid groups of the Hb. A 3 gm/dL solution, as used in this study, has a colloid osmotic pressure of approximately 39 mm Hg. In comparison, similar concentrations of human serum albumin and purified human hemoglobin Aₒ have colloid osmotic pressures of 9 mm Hg. The amount of human serum albumin used in both preservation solutions in this study, 0.15 gm/dL, has an oncotic pressure on the order of 1 mm Hg. The average calculated molecular weight for unmodified and intramolecularly cross-linked human tetramers is 65,300:1:3500 compared to 117,000 for bovine PEG-Hb. When added to Bretschneider's HTK cardioplegic solution, PEG is associated with improved recovery of left ventricular function as well as less myocardial edema, and it is likely that the onconicity of the PEG solution plays an important role. The mechanism of action of PEG may also involve suppression of lipid peroxidation.

The preservation solution was made hypocalcemic because the intracellular accumulation of calcium during ischemia and reperfusion is associated with cellular injury and a hypoxically stressed heart may be protected by a hypocalcemic solution. The solution was normokalemic in order to keep the heart beating, since a beating heart may be less susceptible to edema. Finally, the preservation solution was slightly hypermagnesemic because magnesium inhibits the membrane transport of calcium, and thus intracellular accumulation of calcium, which should help to prevent the deleterious effects of calcium. Magnesium has been shown to attenuate deleterious effects of calcium in ischemic piglet hearts, which are more sensitive to the detrimental effects of calcium than are adult hearts.

There is tremendous value to lengthening the window of cardiac preservation. First, less ischemia to the donor organ will likely improve post-transplant graft function and recipient survival. Second, lengthening the window of cardiac preservation will allow prospective HLA matching as well as the transport of hearts over greater distances to better-matched recipients. Continuous perfusion preservation of rabbit hearts for 8 hrs with PEG-Hb at 30 mmHg and 20° C. yields left ventricular function that is superior to 8-hr perfusion with a chemically similar crystalloid solution without addition of PEG-Hb, despite similar myocardial edema. This study addresses myocardial performance following perfusion with and without the PEG-hemoglobin oxygen carrier, since the control group does not really represent an alternate myocardial preservation scheme. Similarly, the mechanism of preservation using this PEG-Hb solution may or may not involve enhanced oxygen delivery.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention which could be more broadly or narrowly defined later by patent claims.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use later in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in later defined claims or that a single element may be substituted for two or more elements in later defined claims.

Insubstantial changes from the claimed subject matter as viewed by a person with ordinary skill in the art, now known or later devised, are expressly contemplated as being equivalently within the scope of the invention. Therefore, obvious substitutions now or later known to one with ordinary skill in the art are defined to be within the scope of the defined elements.

The invention is thus to be understood to include what is specifically illustrated and described above, what is conceptionally equivalent, what can be obviously substituted and also what essentially incorporates the essential idea of the invention.

1. A composition for donor organ preservation for transplantation comprising a crystalloid based solution of constituents including PEG-Hb, one or more physiologically essential electrolyte, at least one soluble protein, at least one nutritional formulation, and at least one agent acting on the cardiovascular system.

2. The composition of claim 1 where said electrolyte comprises MgSO₄, KCl, CaCl₂, NaCl, NaHCO₃, and Na₂HPO₄ or both.

3. The composition of claim 1 where said at least one soluble protein comprises human albumin.

4. The composition of claim 1 where said at least one soluble protein comprises human insulin.

5. The composition of claim 1 where said at least one nutritional formulation comprises a simple sugar.

6. The composition of claim 5 where said simple sugar comprises dextrose.

7. The composition of claim 1 where said at least one nutritional formulation comprises a carbohydrate and its metabolites.

8. The composition of claim 1 where said at least one nutritional formulation comprises an antioxidant.

9. The composition of claim 8 where said antioxidant is at least one selected from the group comprising glutathione, lipoic acid, N-acetyl cysteine, tocopherols, ascorbic acid, L-thiazolidine-2-one-4-carboxylic acid.

10. The composition of claim 1 where said at least one agent acting on the cardiovascular system comprises heparin sodium.

11. The composition of claim 1 where said at least one agent acting on the cardiovascular system comprises lidocaine HCl.

12. The composition of claim 1 where said crystalloid based solution comprises approximately 3% PEG-Hb by volume.

13. The composition of claim 1 where at least one of the constituents comprises one selected from the group of KCl (4.7 mEq/L), NaCl (148.7 mmol/L), Na₂HPO4/NaH₂PO₄ (2.5 mmol/L), NaHCO₃ (2.5 mmol/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), 0.3M tromethamine (THAM) solution (7.3 cc/L).

14. The composition of claim 1 wherein said crystalloid based solution has a pH maintained at 7.1 as measured at 37° C.

15. The composition of claim 1 wherein crystalloid based solution has a pH maintained at 7.4 as measured at 20° C.

16. The composition of claim 1 where crystalloid based solution is used for ex vivo preservation of donor organ allografts during transportation for the purpose of transplantation.

17. The composition of claim 1 where said crystalloid based solution is used for in vivo myocardial preservation during open-heart surgery.

18. The composition of claim 1 where said crystalloid based solution is used as a blood substitute or blood replacement.

19. The composition of claim 1 where said crystalloid based solution is modified to increase the potassium concentration to reflect intracellular levels for the purposes of achieving cardioplegia or hypothermic cardiac arrest.

20. A comparison for donor organ preservation for transplantation comprising a polyethylene glycol substituted bovine hemoglobin based solution for the purpose of ex vivo donor organ preservation to preserve donor human and animal organs, ex vivo, prior to transplantation.

21. The composition for donor organ preservation of claim 20 where said polyethylene glycol substituted bovine hemoglobin based solution comprises PEG-Hb, and at least one of the constituents selected from the group of human albumin, dextrose, heparin sodium, lidocaine HCl, MgSO₄, KCl, CaCl₂, 0.3M tromethamine (THAM) solution, NaCl, NaHCO₃, and Na₂HPO4/NaH₂PO₄.

22. The composition for donor organ preservation of claim 21 where said polyethylene glycol substituted bovine hemoglobin based solution comprises approximately 3% PEG-Hb by volume.

23. The composition of claim 22 where at least one of the constituents comprises one selected from the group of KCl (4.7 mEq/L), NaCl (148.7 mmol/L), Na₂HPO4/NaH₂PO₄ (2.5 mmol/L), NaHCO₃ (2.5 mmol/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), 0.3M tromethamine (THAM) solution (7.3 cc/L).

24. A composition for donor organ preservation for transplantation of a donor organ comprising an oxygen, nutritional and electrolyte environment for tissue of said donor organ to provide ex vivo preservation such that said donor organ regains acceptable function post transplantation.

25. The composition for donor organ preservation of claim 24 where said oxygen, nutritional and electrolyte environment comprises PEG-Hb, and at least one of the constituents selected from the group of human albumin, dextrose, heparin sodium, lidocaine HCl, MgSO₄, KCl, CaCl₂, 0.3M tromethamine (THAM) solution, NaCl, NaHCO₃, and Na₂HPO4/NaH₂PO₄.

26. The composition for donor organ preservation of claim 24 where said oxygen, nutritional and electrolyte environment comprises approximately 3% PEG-Hb by volume.

27. The composition of claim 24 where at least one of the constituents comprises one selected from the group of KCl (4.7 mEq/L), NaCl (148.7 mmol/L), Na₂HPO₄/NaH₂PO₄ (2.5 mmol/L), NaHCO₃ (2.5 mmol/L), MgSO₄ (5.0 mEq/L), CaCl₂ (1.0 mEq/L), lidocaine HCl (12.5 mg/L), heparin sodium (1250 units/L), dextrose (6.1 mOsm/L), human albumin (1.5 gm/L), human insulin (30.6 units/L), 0.3M tromethamine (THAM) solution (7.3 cc/L).

28. A method for harvesting donor organs comprising:
excising said donor organ;
perfusing said donor organ with a normokalemic hypocalcemic bovine PEG-Hb based solution; and
preserving said donor organ at a temperature for a predetermined time while continuing perfusion with said normokalemic hypocalcemic bovine PEG-Hb based solution in an oxygenated environment.

29. The method of claim 28 where preserving said donor organ in an oxygenated environment comprises oxygenating said normokalemic hypocalcemic bovine PEG-Hb based solution with 95% O₂/5% CO₂.

30. The method of claim 28 where perfusing said donor organ with a normokalemic hypocalcemic bovine PEG-Hb based solution comprises continuously perfusing PEG-Hb, and at least one of the constituents selected from the group of human albumin, dextrose, heparin sodium, lidocaine HCl, MgSO₄, KCl, CaCl₂, Tromethamine (THAM) solution, NaCl, NaHCO₃, and Na₂HPO₄/NaH₂PO₄.
